(19) United States
(12) Patent Application Publication
(10) Pub. No.: US 2003/0062726 A1
(43) Pub. Date: Apr. 3, 2003

(54) Door hook for residential metal storm and screen doors and method of using same

(76) Inventor: Richard V. Corbett, Sleepy Hollow, IL (US)

Correspondence Address: James E. Brunton, Esquire, Suite 860, 700 N. Brand Blvd., Post Office Box 29000, Glendale, CA, 91203, US

(21) Appl. No.: 10/145,293

(22) Filed: May 14, 2002

Related U.S. Application Data
(60) Provisional application No. 60/325,475, filed on Sep. 28, 2001.

(51) Int. Cl. E05C 19/10

(52) U.S. Cl. 292/101

(57) ABSTRACT

A door hook assembly that can be used in combination with a wooden doorframe within which a metal screen or storm door is hingedly mounted. More particularly, the door hook assembly of the invention is of a simple construction that can be quickly and easily connected to a conventional wooden doorframe and metal screen or storm door having a hollow frame. The door hook assembly includes a unique binding post component for securing the hook portion of the assembly to the metal screen or storm door.

### BACKGROUND OF THE INVENTION

This is a Non-provisional Application based on Provisional Application Serial No. 60/325,475 filed Sep. 28, 2001.

1. Field of the Invention

The present invention relates generally to fastening devices. More particularly the invention concerns a novel door hook assembly and the method of using same for use in combination with door assemblies comprising a wooden frame and a metal door hingedly connected to the wooden frame.

2. Discussion of the Prior Art

For many years storm and screen doors were constructed from wood. However, in recent years metal storm and screen doors have become very popular. As a general rule, these metal storm and screen doors comprise a hollow core, metal mounting frame within which screen and glass panels may be mounted.

The typical prior art door or gate hook assembly comprises a screw eye which is screwed into the wooden door frame and a corresponding screw eye and hook that is secured to the wooden door or gate. This type of door or gate hook assembly cannot readily be used with the newer metal screen or storm doors because the conventional screw eye cannot be screwed into the metal mounting frame of the door. Accordingly, an entirely new type of door hook assembly was needed to accomplish the purpose of the prior art door or gate assemblies that were specifically designed for use with wooden doorframes and wooden screen or storm doors. As will be better understand from the discussion which follows, the novel hook assembly of the present invention is ideally suited for use in connection with conventional metal storm and screen doors. More particularly, the novel hook assembly of the present invention provides a unique means for securing the hook portion of the assembly to the metal screen or storm door.

### SUMMARY OF THE INVENTION

It is an object of the present invention to provide a door hook assembly that can be used in combination with a wooden doorframe within which a metal screen or storm door is hingedly mounted.

Another object of the invention is to provide a door hook assembly of the aforementioned character that includes unique means for securing the hook portion of the assembly to the metal screen or storm door.

Another object of the invention is to provide a door hook assembly as described in the preceding paragraphs, which is of simple construction and can be quickly and easily connected to a conventional wooden doorframe and metal screen or storm door having a hollow frame.

Another object of the invention is to provide a door hook assembly of the character described that can be inexpensively manufactured and is durable and reliable and use.

### BRIEF DESCRIPTION OF THE DRAWINGS

FIG. 1 is a front view of one form of the door hook assembly of the present invention used in combination with a door assembly comprising a wooden frame and a metal door hingedly connected to the wooden frame.

FIG. 2 is a greatly enlarged, fragmentary view of the area designated as 2-2 and FIG. 1.

FIG. 3 is a greatly enlarged cross-sectional view taken along lines 3-3 of FIG. 1.

FIG. 4 is a generally perspective, exploded view of the door hook assembly shown in FIG. 1.

### DESCRIPTION OF THE INVENTION

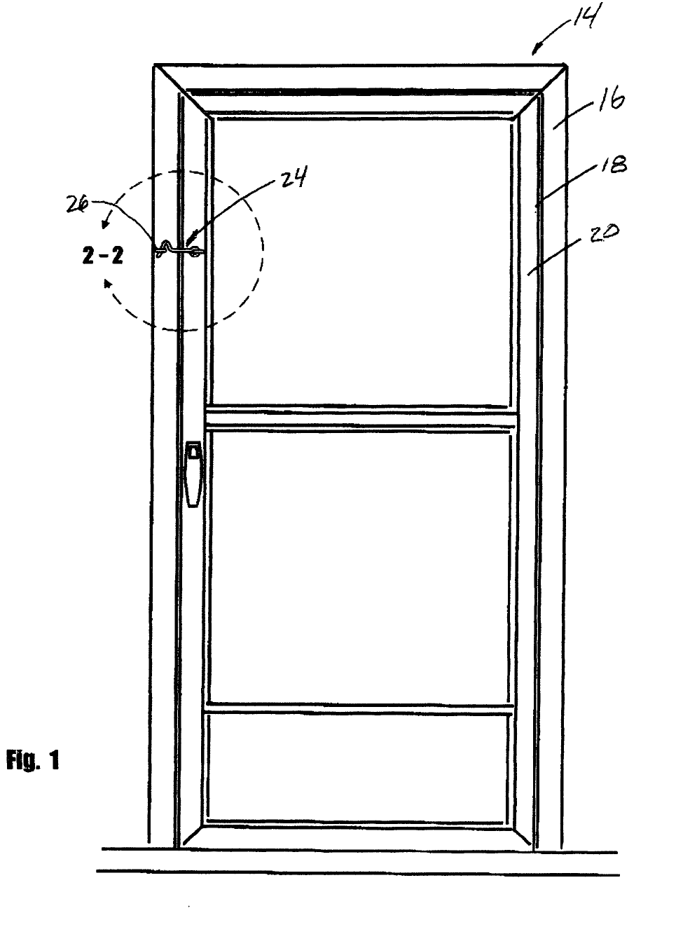

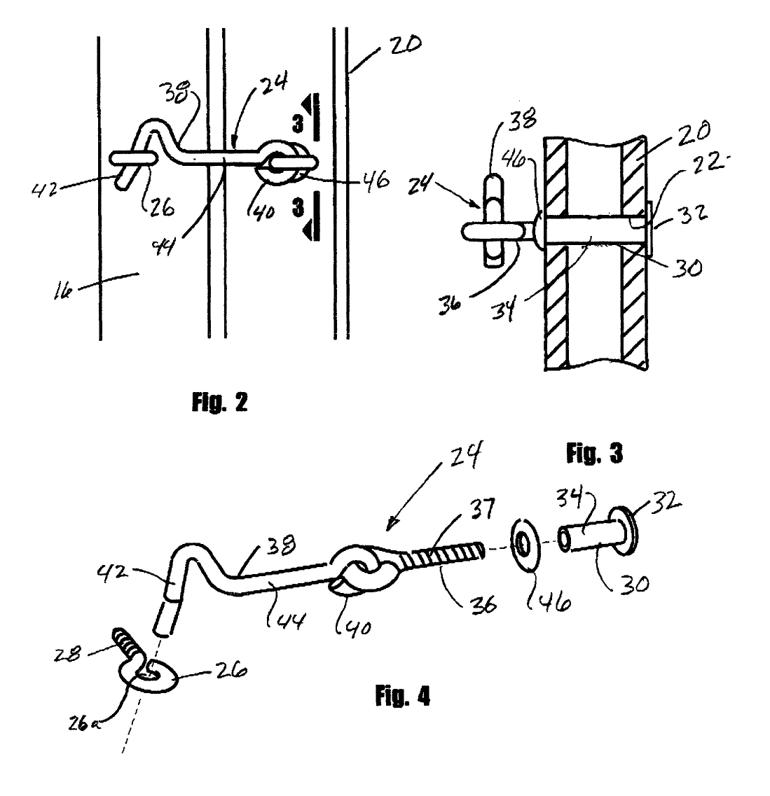

Referring to the drawings and particularly FIGS. 1 and 2, one form door hook assembly of the present the invention shown interconnected a door assembly 14 that comprises a wooden frame 16 and a metal door 18 that is hingedly connected to the wooden frame. The metal door 18 includes a hollow marginal portion 20 that has a bore 22 there through (FIG. 3).

In the present form of the invention, the door hook assembly 24 comprises a screw eye 26 having a threaded shank 28 for threadable interconnection with the wooden frame 16 of the door assembly (FIG. 2). Also forming part of the door and assembly of the invention is a binding post 30 that includes a head portion 32 and an internally threaded shank portion 34. As shown in FIG. 3, shank portion 34 is closely received within the bore 22 formed in the hollow marginal portion 20 of the door 18. A threaded eye bolt 36 having an externally threaded shank portion 37 is threadably interconnected with the threaded shank portion 34 of said binding post in the manner shown in FIG. 3 (see also FIG. 4).

Also forming part of the door and assembly of the invention is a door hook assembly 38 that can be interconnected with screw eye 26 the manner best seen in FIG. 2. Door hook assembly 38 includes an eye portion 40, a hook portion 42 and a shank portion 44. As indicated in FIGS. 2 and 4, eye portion 40 is pivotally interconnected with threaded eyebolt 36 so as to facilitate introducing the portion 42 into the eye 26a and screw eye 26 (FIG. 2).

To secure the binding post 30 within bore 22, there is provided a finishing washer 46 that is carried by threaded eye bolt 36 for engagement with the mounting frame of the metal door when the threaded eye bolt is fully threaded into binding post 30 (see FIG. 3).

The method of the present invention comprises using the door hook assembly 24 in combination with the door assembly 14 to releasably secure the metal door in a closed position within the wooden frame 16. More particularly, the method of the invention includes the step of first drilling the hollow mounting frame of the metal door to form bore 22 there through. This done, the binding post 30 is inserted into the bore in the hollow mounting frame, washer 46 is positioned over the shank portion 37 of the eye bolt 36 and the threaded shank portion 37 of the eye bolt 36 is threaded into the internally threaded shank 34 of the binding post 30 to a position wherein washer 46 is in engagement with the outer surface of the metal door frame 20. Finally, the screw eye 26 is threadably interconnected with the wooden frame 16 of the door assembly.

With the various components of the door hook assembly of the invention interconnected with the doorframe and with the metal door in the manner described in the preceding paragraphs, the hook portion 42 of the door assembly 38 can be conveniently inserted into and removed from the eye 26a of screw eye 26.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following documents.

I claim:

1. A door hook assembly for use in combination with a door assembly comprising a wooden frame and a metal door hingedly connected to the wooden frame, the metal door including a hollow marginal portion having a bore there through, said door hook assembly comprising:
(a) a screw eye having a threaded shank for threadable interconnection with the wooden frame of the door assembly;
(b) a binding post having a threaded shank portion receivable within the bore in the hollow marginal portion of the door;
(c) a threaded eye bolt threadably interconnected with said threaded shank portion of said binding post; and
(d) a door hook assembly having an eye portion, a hook portion and a shank portion, said eye portion being pivotally interconnected with said threaded eyebolt.

2. The door assembly as defined in claim 1 in which said threaded shank portion of said binding post is provided with internal threads and in which said threaded eye bolt is provided with external threads.

3. The door assembly as defined in claim 1 further including a finishing washer carried by said threaded eye bolt for engagement with the mounting frame of the metal door.

4. A door hook assembly for use in combination with a door assembly comprising a wooden frame and a metal door hingedly connected to the wooden frame, the metal door including a hollow mounting frame having a bore there through, said door hook assembly comprising:
(a) a screw eye having a threaded shank for threadable interconnection with the wooden frame of the door assembly;
(b) a binding post having an internally threaded shank portion receivable within the bore in the hollow frame;
(c) an externally threaded eyebolt threadably interconnected with said threaded shank portion of said binding post;
(d) a door hook assembly having an eye portion, a hook portion and a shank portion disposed intermediate set eye portion and said hook portion, said eye portion being pivotally interconnected with said screw eye; and
(e) a finishing washer carried by said threaded eyebolt for engagement with the mounting frame of the metal door.

5. A method of using a door hook assembly in combination with a door assembly comprising a wooden frame and a metal door hingedly connected to the wooden frame, the metal door including a hollow mounting frame and the door hook assembly comprising a screw eye having a threaded shank; a binding post having an internally threaded shank portion; an eye bolt having an eye portion and an externally threaded shank portion; and a door hook assembly having an eye portion, a hook portion and a shank portion the hook portion, the eye portion being pivotally interconnected with eye portion of the eye bolt to form a hook and eye bolt assembly, said method comprising the steps of:
(a) drilling the hollow mounting frame of the metal door to form a bore there through;
(b) inserting the binding post into the bore in the hollow mounting frame;
(c) threadably interconnecting the threaded shank portion of the eye bolt with the binding post; and
(d) threadably interconnecting the screw eye with the wooden frame of the door assembly.

6. The method as defined in claim 6 in which the door hook assembly further includes a finishing washer and in which said method further includes the step of placing the finishing washer over the externally threaded shank portion of the eyebolt prior to threadably interconnecting the threaded shank portion of the eye bolt with the binding post.
